(19) United States
(12) Patent Application Publication
(10) Pub. No.: US 2007/0289814 A1
(43) Pub. Date: Dec. 20, 2007

(54) Oil drain plug remover

(76) Inventor: George McLure Sawyer, Norwich, CT (US)

Correspondence Address: HEDMAN & COSTIGAN P.C., 1185 AVENUE OF THE AMERICAS, NEW YORK, NY, 10036, US

(21) Appl. No.: 11/395,994

(22) Filed: Mar. 31, 2006

(51) Int. Cl. F16C 3/14

(52) U.S. Cl. 184/1.5

(57) ABSTRACT

An oil drain plug remover comprising a deflector portion and a receptacle for receiving at least a portion of a drain plug head for directing the used oil stream from an oil drain hole of an engine and a method for using the oil drain plug remover.

### FIELD OF THE INVENTION

The present invention relates generally to the field of mechanical tools for engine maintenance, and more particularly to tools for assisting in changing oil.

### BACKGROUND OF THE INVENTION

Engines, as used in automobiles, trucks, boats, planes, power equipment and the like, require oil to lubricate moving parts. The oil is used to prevent excess wear, increase efficiency and engine life. However, oil used in engines tends to break down with use over a period of time, such that the lubricity is reduced and the potential for wear increases. Therefore, the oil must be changed regularly to keep an engine running properly.

Since engine design commonly takes into account the fact that the oil needs to be changed regularly, the oil generally collects into an oil pan with a drain plug at the lowest point when the engine is not in use. An oil drain plug usually comprises a threaded bolt with a hexagonal bolt head that fits into a threaded hole in the oil pan, so that removal of the bolt permits the used oil to flow from the oil pan.

The threaded hole at the lowest point of the oil pan is most often on an angled portion of the pan. As such, the oil drain plug, or bolt, is removed at an angle of about 60 degrees from horizontal.

Moreover, there is often over 5 quarts of oil in an automobile, and more in most truck or larger engines, creating a head pressure above the drain hole. Although the used oil tends to drip out as the oil drain plug is loosened, the head pressure of the oil above the drain hole causes the used oil to rush out when the oil drain plug is first fully removed. The strength of the oil flow then diminishes fairly quickly as the used oil drains. Because the drain hole is formed on the oil pan at an angle, the oil dripping while loosing the drain plug falls vertically downward but the initial rush of oil and subsequent flow of used oil is at an angle outward from the drain hole.

When draining the oil, the initial rush of oil at an angle to the engine begins as the final turn of the drain plug is made to fully remove the drain plug from the drain hole. The initial force of the oil exiting the drain hole is so great that the technician removing the drain plug cannot move his hands out of the way quickly enough, so that his fingers are in the stream of hot, dirty engine oil exiting the drain hole under the head pressure. The technician therefore ends up with burned, dirty fingers.

Additionally, to assist in draining used oil, catch basins are used by the technician to catch the used oil emerging from the oil pan. Generally, the catch basin is a bowl shaped container with a flat bottom, raised side walls and an open top of a fixed diameter to catch the used oil.

Due to the vertically dripping oil when loosening the drain plug, the sudden pressure of the oil emerging from the angled drain hole when the oil drain plug is fully removed and the decreasing angle of the emerging oil as the oil drains and the pressure is reduced, judging where to locate the catch basin can be difficult.

Placing the catch basin too close to the area beneath the drain hole to catch the initial drips usually results in the rush of used oil when the drain plug is fully removed to overshoot the catch basin and land on the garage floor or driveway. Placing the catch basin too far from the area beneath the drain hole usually results in missing the initial drips while the drain plug is being loosened and the oil not making it to the catch basin as the oil flow decreases.

It is therefore an object of the invention to provide a way to control the flow of used oil from the drain hole of an oil pan and into a catch basin.

### SUMMARY OF THE INVENTION

This and other objects are achieved by the present invention which is directed to an oil drain plug remover comprising a deflector portion and a receptacle within the deflector portion for receiving at least a portion of the drain plug.

In its preferred embodiment the deflector portion is formed in a substantially circular configuration and the receptacle is placed in about the middle of the deflector portion. The deflector portion of the present device also preferably includes a directional edge, to direct the used oil inward toward the catch basin and provide structural rigidity to the deflector portion.

The receptacle can be formed either as a closed or an open receptacle. In either embodiment, the size of the receptacle should be about the size of the drain plug head. If a closed configuration of the receptacle is used, the depth of the receptacle should be at least sufficient for the technician to grasp exterior of the closed receptacle to turn the drain plug and is preferably equal to or slightly greater than the depth of the drain plug head.

Depending on the materials chosen, the receptacle can be slightly larger than the drain plug head. A closed receptacle made of a soft or flexible material can be slightly larger than the drain plug head so that the technician can deform the sides of the receptacle portion to grasp the drain plug head for removal. Alternatively, the closed receptacle can be formed to narrow as it moves away from the opening of the receptacle. Either will permit the same oil drain plug remover to fit a number of different sized drain plug heads. Similarly, if an open receptacle of a flexible material is used it can be pushed over different sized drain plug heads.

If a more rigid material is used, the receptacle must be generally sized to fit a particular drain plug head, either through the use of defined sizes for particular sized drain plug heads, an adjustable receptacle or adapters.

The present invention can be formed of any suitable material, especially metal, plastic or paper products. The receptacle can be made of either the same or a different material than the deflector portion. The most significant requirement in determining the material to be used, however, is the rigidity of the material used for the deflector portion. In this regard, if the deflector portion is not sufficiently rigid the rush of oil created when the drain plug is first fully removed will deform the deflector portion without controlling the direction of the flow of oil.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is a rear elevation of an oil drain plug remover in accordance with the present invention.

FIG. 2 is a cross section of the oil drain plug remover taken through line A-A of FIG. 1.

FIG. 3 is a rear perspective of the oil drain plug remover of FIG. 1.

FIG. 4 is a front perspective of the oil drain plug remover of FIG. 1.

FIG. 5 is a rear elevation of an alternative embodiment of the oil drain plug remover of the present invention having an open receptacle.

FIG. 6 is a cross section of the oil drain plug remover of FIG. 5 having an open receptacle.

FIG. 7 is a rear elevation of the alternative embodiment of the oil drain plug remover of FIG. 5 having a receptacle made of a different material than the deflector portion.

FIG. 8 is a cross section of the oil drain plug remover of FIG. 7 having a receptacle made of a different material than the deflector portion.

### DETAILED DESCRIPTION OF THE PREFERRED EMBODIMENT

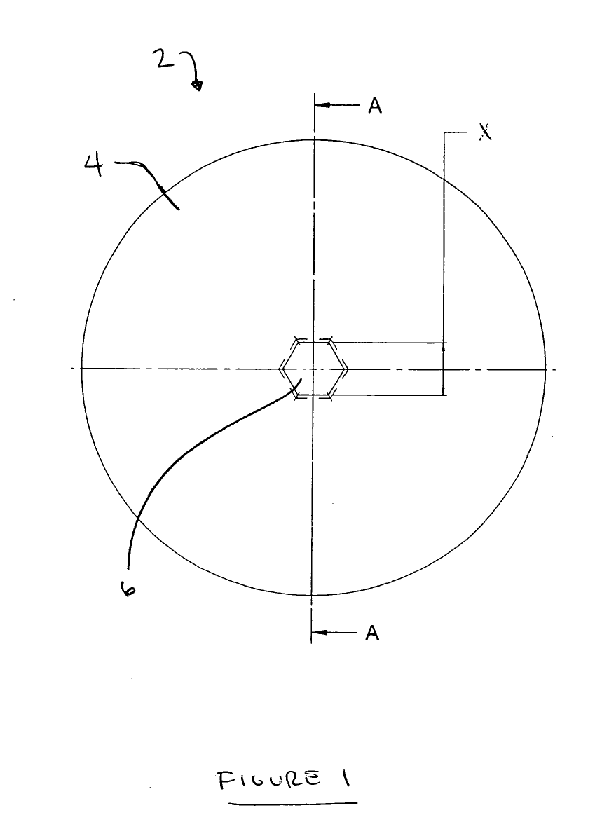

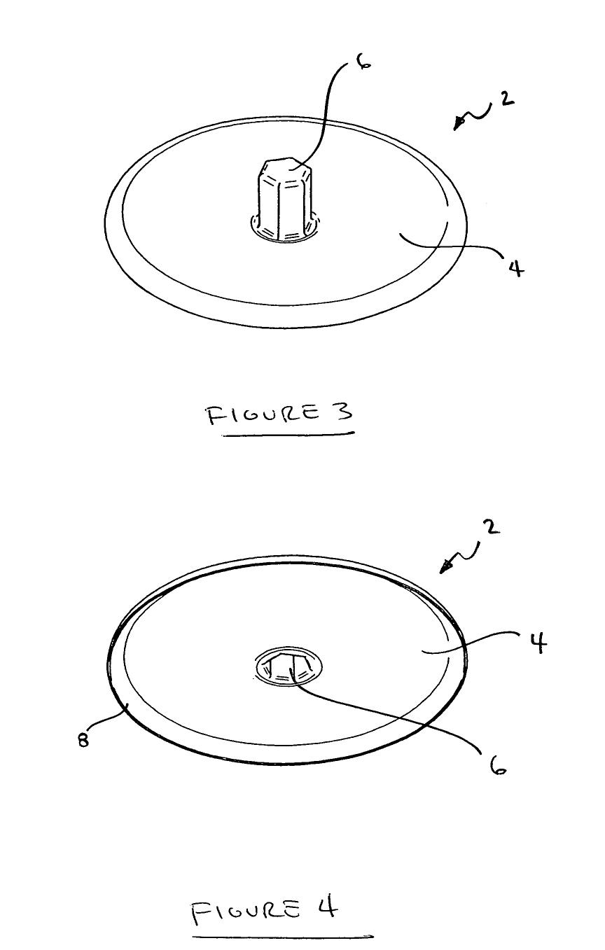

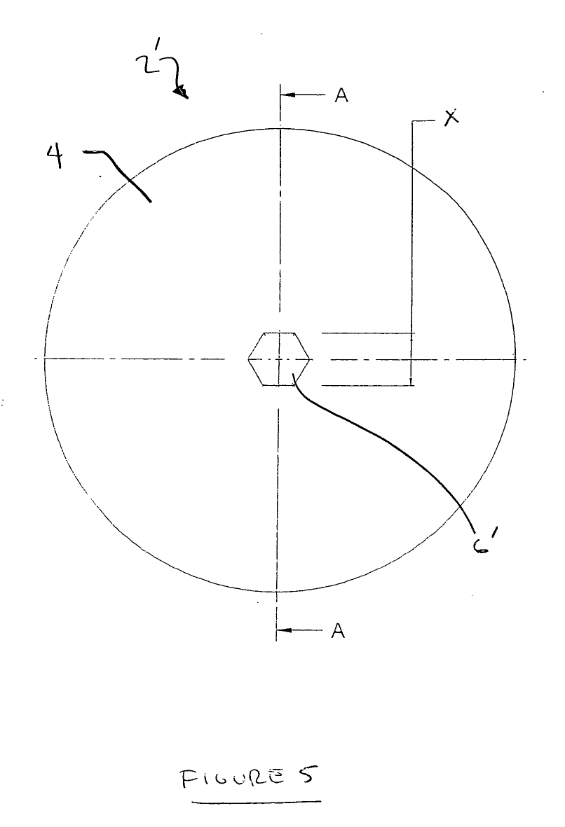

As shown in the drawings, and each of FIGS. 1-8, the present invention is directed to an oil drain plug remover 2 comprising deflector portion 4 and a receptacle 6.

In its preferred embodiment, the deflector portion 4 is formed in a substantially circular configuration. This permits a uniform flow of the used oil off of the deflector portion 4 into a catch basin below. Although the particular size of the deflector portion is not essential, it is preferred that the circular deflector portion 4 have a diameter of from about 3 to about 7 inches, with a diameter of about 5 inches being most preferred.

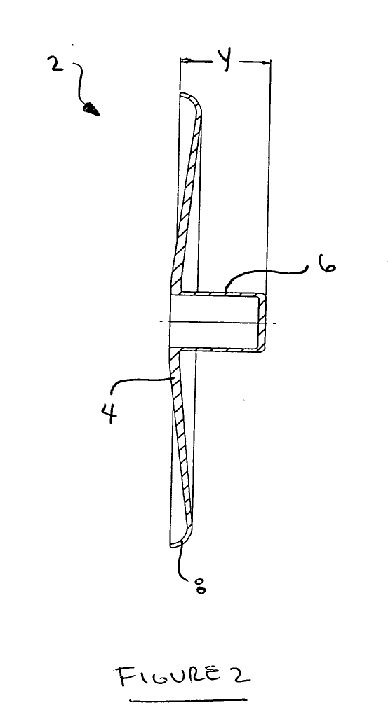

It is also preferred that the deflector portion have a directional edge 8 to further deflect the used oil inward, and away from the user, as shown in FIGS. 2, 4, 6 and 8. Although the directional edge 8 is shown in the attached drawings as comprising a curved edge, it is understood that the particular configuration of the directional edge 8 is not of particular importance and can be angled, etc., as long as it functions to direct the used oil away from the user's hand and into a catch basin.

In the embodiment shown in FIGS. 1-4, the receptacle 6 is formed as a closed receptacle 6 that fits over the generally hexagonal drain plug head. Thus, the used oil will not get through the oil drain plug remover 2 even if it is not properly seated on the oil drain plug head during use.

The opening X of the receptacle 6, as shown in FIG. 1, should be about the size of the drain plug head, with the depth Y of the receptacle 6, shown in FIG. 2, being at least sufficient for the technician to grasp exterior of the closed receptacle. In its most preferred embodiment, the depth Y of the receptacle 6 is equal or slightly greater than the depth of the drain plug head. It has been found that the most preferred depth Y of the receptacle 6 in the embodiment shown in FIG. 2 is between about 0.75 inches and about 1.25 inches, with about 1.06 inches being most preferred.

The exterior of the preferred closed receptacle 6 shown in FIGS. 1-4 is merely the hexagonal shape of the drain plug head. It is understood, however, that the exterior can be formed with virtually any shape or surface to permit the user to grasp and turn the oil drain plug remover. For example, the outer portion of the receptacle 6 can be formed in a circular rather than hexagonal configuration, with ridges or a roughened surface for the user to gain a grip on the oil drain plug remover for rotation of the oil drain plug remover 2, and therefore the oil drain plug.

Depending on the materials chosen, the size of the opening X of the receptacle 6 can be slightly larger than the drain plug head. A closed receptacle 6 made of a semi-soft or flexible material can be slightly larger than the drain plug head so that the user can deform the sides of the receptacle 6 to narrow a larger receptacle 6 about a slightly smaller drain plug head for removal. Alternatively, the closed receptacle 6 can be formed to narrow as it moves away from the opening of the receptacle 6 (not shown) so that sliding the receptacle 6 further onto the drain plug head will more firmly engage smaller drain plug heads. Another embodiment found to be suitable to the present invention is the use of adapters within the receptacle 6 that fit specific size oil drain plug heads that are smaller than the size X of the opening of the receptacle 6. Each potential embodiment, as well as others known to those skilled in the art, will permit the same oil drain plug remover 2 to fit a number of different sized drain plug heads.

However, in the preferred embodiment the size of the opening X of the receptacle 6 is substantially specific to the size of the drain plug head. Thus, an oil drain plug remover 2 contemplated for use in removing a drain plug having a hexagonal drain plug head of 0.625 inches will preferably have an opening X of about 0.630 inches.

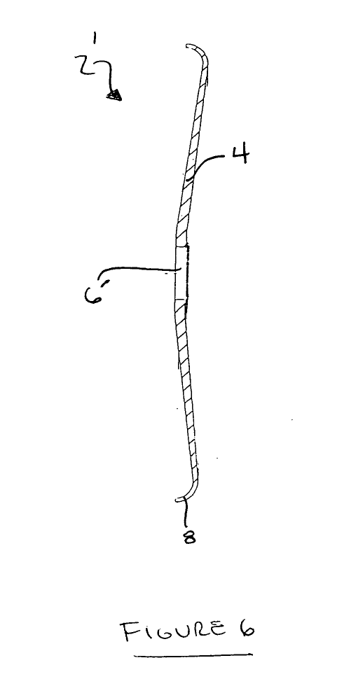

In the alternative embodiments of FIGS. 5-8, the oil drain plug remover 2 is formed with an open receptacle 6′. Although these embodiments permit ease of storage, since the oil drain plug remover 2 is substantially flat, without the raised area of the closed receptacle 6, it must be used more carefully to ensure that the used oil does not pass through the receptacle 6′ when it emerges from the drain hole. Notwithstanding, the embodiments with the open receptacle 6′ permit the user to place a tool such as a ratchet or wrench over the drain plug head with the oil drain plug remover 2 in place.

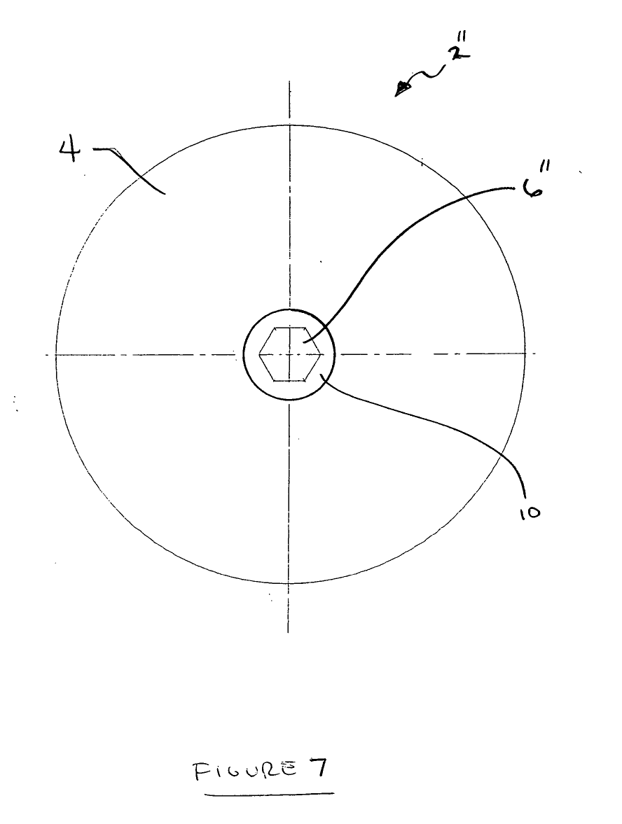

The embodiment shown in FIGS. 5 and 6 are formed with the size X of the receptacle 6′ being substantially that of the size of the drain plug head. Thus, an oil drain plug remover 2′ contemplated for removing a drain plug with a hexagonal drain plug head of 0.0625 inches will preferably have an opening X of about 0.630 inches.

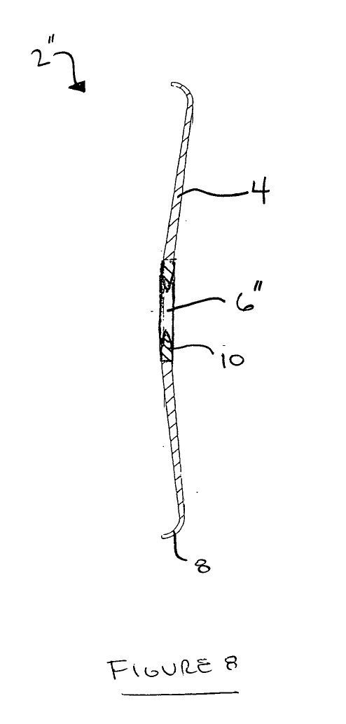

The embodiment shown in FIGS. 7 and 8 alternatively include a receptacle 6″ with a flexible member 10 to form a relatively sealed fit over the drain plug head. In this embodiment, it is preferred that the flexible member 10 be formed of an elastomeric material that can flex to permit acceptance of at least a narrow range of different sized drain plug heads.

The oil drain plug remover 2, in any of the embodiments shown, can be any suitable material, especially metal, plastic or paper products. The receptacle 6 can be made of either the same or a different material than the deflector portion, even when using the closed receptacle configuration of FIGS. 1-4. The most significant requirement in determining the material to be used, however, is the rigidity of the material used for the deflector portion 4. In this regard, if the deflector portion is not sufficiently rigid the rush of oil created when the drain plug is first fully removed will deform the deflector portion without controlling the direction of the flow of oil.

In the preferred embodiment, the oil drain plug remover 2, 2′ or 2″ is made of an oil resistant plastic. The closed receptacle 6, when used, is formed of the same material in a single injection molding process. Alternatively, the oil drain plug remover can be made of metal, such as aluminum or steel, to provide a long life product, or made of a paper material, such as a heavy paper, oak tag or cardboard material, to provide a disposable product.

In using the device of the present invention, the user will first loosen the oil drain plug. If the oil drain plug remover 2 is formed with a closed plastic, paper or otherwise structurally limited receptacle 6, the oil drain plug will be loosened prior to engagement of the drain plug by the receptacle. Once loosened, the user places the closed receptacle 6 over the drain plug head and continues to loosen the drain plug until the drain plug is removed from the drain hole. The oil drain plug remover is held in the area adjacent the drain hole by the user for the period of time that the used oil is rushing through the drain hole, directing the used oil downward into a catch basin below.

If the closed receptacle 6 of the oil drain plug remover 2 is formed of a material with the appropriate structural integrity, or if the oil drain plug remover 2′ or 2″ is formed with an open receptacle 6′ or 6″, the oil drain plug remover 2 can be placed over the drain plug head prior to loosing. The loosening tool can then be either placed over the exterior of the closed receptacle 6, or directly on the drain plug head when using an open receptacle 6′ or 6″ to loosen the drain plug. Similarly, the oil drain plug remover is held in the area adjacent the drain hole by the user for the period of time that the used oil is rushing through the drain hole, directing the used oil downward into a catch basin below.

Variations, modifications and alterations to the preferred embodiment of the present invention described above will make themselves apparent to those skilled in the art. All such changes are intended to fall within the spirit and scope of the present invention, limited solely by the appended claims.

All patents referred to herein are hereby incorporated by reference.

I claim:

1. An oil drain plug remover comprising a deflector portion and a receptacle for receiving at least a portion of a drain plug head.

2. The oil drain plug remover of claim 1 wherein the deflector portion is substantially circular.

3. The oil drain plug remover of claim 2 wherein the deflector portion has a diameter of from about 3 inches to about 7 inches.

4. The oil drain plug remover of claim 3 wherein the deflector portion has a diameter of about 7 inches.

5. The oil drain plug remover of claim 1 wherein the deflector portion includes a directional edge.

6. The oil drain plug remover of claim 1 wherein the receptacle is closed about the portion of the drain plug head received thereby.

7. The oil drain plug remover of claim 1 wherein the receptacle is open to allow at least a portion of the drain plug head to pass through.

8. The oil drain plug remover of claim 1 wherein the oil drain plug remover is formed of a unitary material.

9. The oil drain plug remover of claim 8 wherein the oil drain plug remover is formed of a material taken from the group consisting of plastic, metal or paper material.

10. The oil drain plug remover of claim 9 wherein the oil drain plug remover is formed of an oil resistant plastic material.

11. The oil drain plug remover of claim 10 wherein the oil drain plug remover is injection molded of the oil resistant plastic material.

12. The oil drain plug remover of claim 7 wherein the oil drain plug remover is formed of a unitary material.

13. The oil drain plug remover of claim 12 wherein the oil drain plug remover is formed of a material taken from the group consisting of plastic, metal or paper material.

14. The oil drain plug remover of claim 13 wherein the oil drain plug remover is formed of an oil resistant plastic material.

15. The oil drain plug remover of claim 14 wherein the oil drain plug remover is injection molded of the oil resistant plastic material.

16. The oil drain plug remover of claim 7 wherein the oil drain plug remover is formed of a first material for the deflector portion and a second material for the receptacle.

17. The oil drain plug remover of claim 16 wherein the first material is taken from the group consisting of plastic, metal or paper material and the second material is an elastomeric material.

18. A method of removing an oil drain plug from an oil drain hole to drain used oil from an engine comprising the steps of inserting at least a portion of an oil drain plug head into a receptacle of an oil drain plug remover comprising a deflector portion and a receptacle, loosening the drain plug head and holding the oil drain plug remover adjacent the oil drain hole to direct the used oil emerging from the drain hole downward into a catch basin.

19. The method of claim 18 further comprising loosening the oil drain plug prior to inserting the oil drain plug head into the receptacle.
